(19) United States
(12) Patent Application Publication
(10) Pub. No.: US 2024/0263509 A1
(43) Pub. Date: Aug. 8, 2024

(54) Animal Crate Locking Device

(71) Applicants: Derrick Brown, Albuquerque, NM (US); Brian Bennett, Albuquerque, NM (US)

(72) Inventors: Derrick Brown, Albuquerque, NM (US); Brian Bennett, Albuquerque, NM (US)

(21) Appl. No.: 18/341,798

(22) Filed: Jun. 27, 2023

Related U.S. Application Data
(60) Provisional application No. 63/443,562, filed on Feb. 6, 2023.

(51) Int. Cl. E05F 15/77; A01K 1/03; E05B 47/00; E05F 15/63

(52) U.S. Cl. CPC E05F 15/77; A01K 1/034; E05B 47/0002; E05F 15/63

(57) ABSTRACT

An animal crate locking device is disclosed that comprises a body component comprised of a conventional dog kennel crate. Typically, a control box component which houses all the necessary components is secured to the side of the body component. The control box component also comprises a swing arm that can be attached to the kennel door. The control box component comprises means to be connected to a home network and/or security system via a Wi-Fi signal, thereby allowing the user to operate the kennel door via the swing arm at any time through a mobile software application and smart device or programmed through a home security system.

### CROSS-REFERENCE TO RELATED APPLICATION

The present application claims priority to, and the benefit of, U.S. Provisional Application No. 63/443,562, which was filed on Feb. 6, 2023, and is incorporated herein by reference in its entirety.

### FIELD OF THE INVENTION

The present invention relates generally to the field of animal crate locking devices. More specifically, the present invention relates to an improved animal kennel crate with a door that can be operated via a home Wi-Fi network. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in animal crate locking devices. Generally, pet owners may leave their pet in a kennel throughout the day. It is impossible for the pet to leave the kennel unless it is manually opened by the pet owner. However, pet owners may want to have their pets greet them as they come home from a trip, work, or otherwise being away from home. Additionally, pet owners may want to release the pet from the kennel to go outside via a pet door.

Furthermore, if a house fire or other home disaster occurs while a pet is locked in their kennel, he/she may be unable to escape quickly and may be harmed. Additionally, if the owner is upstairs and/or in their room and away from the kennel and an intruder enters the house, a user may want to be able to release their pet from its kennel to provide protection from the intruder.

Accordingly, a need remains for an animal crate locking device that can be automatically opened wirelessly through Wi-Fi. Further, an animal crate locking device is necessary to allow a user to open the kennel door at any time through a mobile software application.

Therefore, there exists a long-felt need in the art for an animal crate locking device that provides users with an improved dog kennel crate with a door that can be operated via a home Wi-Fi network. There is also a long-felt need in the art for an animal crate locking device that allows pet owners to connect the crate to a home network or security system, enabling it to be opened at any time through a software application. Further, there is a long-felt need in the art for an animal crate locking device that enables users to auto open the kennel door on command. Moreover, there is a long-felt need in the art for a device that enables users to auto open the kennel door via a home security system. Further, there is a long-felt need in the art for an animal crate locking device that can be programmed, such that the kennel door opens whenever an exterior door or window is opened. Finally, there is a long-felt need in the art for an animal crate locking device that prevents pets from being stuck in their kennel until a pet owner manually unlatches the kennel door.

The subject matter disclosed and claimed herein, in one embodiment thereof, comprises an animal crate locking device. The device is a dog kennel crate with a door that can be operated wirelessly through Wi-Fi. The animal crate locking device comprises a body component comprised of a conventional dog kennel crate. Typically, a control box component which houses all the necessary components is secured to the side of the body component. The control box component also comprises a swing arm that can be attached to the kennel door. The control box component comprises means to be connected to a home network and/or security system via a Wi-Fi signal, thereby allowing the user to operate the kennel door via the swing arm at any time through a mobile software application and smart device. Further, the kennel door can also be programmed to the home security system, which will allow the kennel door to be opened whenever an exterior door or window is opened. Typically, sensors are placed on windows and doors to communicate with the control box component to control the kennel door.

Generally, batteries or USB device can be used to power the device instead of an AC adapter, if desired.

In this manner, the animal crate locking device of the present invention accomplishes all of the foregoing objectives and provides users with a device that provides a dog kennel door which is operated via a Wi-Fi network. The device enables users to auto open a kennel door. The device can also be controlled via a user's security system.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an animal crate locking device. The device is a dog kennel crate with a door that can be operated wirelessly through Wi-Fi. The animal crate locking device comprises a body component comprised of a conventional dog kennel crate. Typically, a control box component which houses all the necessary components is secured to the side of the body component. The control box component also comprises a swing arm that can be attached to the kennel door. The control box component comprises means to be connected to a home network and/or security system via a Wi-Fi signal, thereby allowing the user to operate the kennel door via the swing arm at any time through a mobile software application and smart device or through a home security system.

In one embodiment, the animal crate locking device can be utilized with any animal crate as is known in the art for temporary storage of a pet. Specifically, the animal crate locking device can be utilized with a dog kennel, a cat kennel, a hamster, other rodent kennel, etc., or any other suitable animal kennel as is known in the art.

In one embodiment, the animal crate locking device comprises a body component which is a conventional dog kennel crate. Generally, the animal crate locking device comprises a body component that is generally box-shaped with a floor, a roof, and side walls. The six faces may be connected to each other using push-fit fasteners to facilitate assembly without tools. The body component has a door opening in which the animal may enter/exit. In one embodiment, the door opening may include a movable door (i.e., hinged or sliding) that may be opened or shut to prevent access to the interior of the body component. The walls of the body component may include one or more openings (i.e., windows) that allow for ventilation and/or light. Further, the body component comprises a door attached to the dog kennel crate via at least one spring-loaded hinge. The door locks in a closed state or unlocks and opens with respect to the dog kennel crate via a lock. In one embodiment, the lock is a magnetic lock that functions via an electromagnet.

In another embodiment, the lock is engaged via a locking motor. Rotational movement of the lock is accomplished either through manual rotation via a user or via the locking motor, which in effect, locks or unlocks the door with respect to the dog kennel crate. The locking motor is powered via electrical power comprised by at least one battery (which may be recharged) and controlled via a central processing unit within the control box component. The central processing unit is in wired communication with a receiver, which communicates with the locking motor.

In one embodiment, the control box component is able to communicate wirelessly with the lock. The control box component includes a touch screen, a Bluetooth transceiver, a cellular transceiver, and the central processing unit. The control box component includes a housing, which may be affixed to the dog kennel crate or door directly. Alternatively, the housing of the control box component may be not affixed to the dog kennel crate or the door in order for the control box component to be a remote hand-held device. Further, the housing includes the touch screen, as well as an on/off button, and a plug port. The plug port enables an electrical cord to plug into and recharge the control box component.

In one embodiment, the control box component is secured to the dog kennel crate via any suitable securing means as is known in the art. The control box component also comprises a swing arm that can be attached to the door. The swing arm is adjustable and controlled by an arm motor. Specifically, the swing arm is engaged via the arm motor, which acts to open and close the door.

Further, the control box component comprises all the necessary components needed for operating the animal crate locking device and the swing arm to open and close the door. Specifically, the control box component comprises at least one controller, wherein the controller is able to communicate with a smart device, lock, and swing arm. The lock further comprises an electronic interface for operation, such that the controller can control the operation of the lock.

In one embodiment, the Bluetooth transceiver of the control box component enables a smart phone to communicate with the device. Moreover, the cellular transceiver of the control box component enables the smart device or a home security system to communicate with the device. The cellular transceiver shall work in the event the smart device is out of range of use with the Bluetooth transceiver. The cellular transceiver communicates directly with a cell phone tower in order to facilitate communication with the smart device or the home security system.

In one embodiment, the smart device is preferably a smartphone running a software application, provided to support the features of the device. The smartphone application provides, when activated, an online connection to an online service provider, and will, when communicating with the swing arm and lock, communicate with the swing arm and lock over a short range, such as Wi-Fi/Bluetooth/NFC, communication protocol. Other standard or short-range communication protocols may be used, also proprietary protocols.

In one embodiment, the smart device many be any suitable smart device, such as a handheld device, phone, tablet, etc., and may be any type of remote control implementing the user interface towards the lock and swing arm operation and to a cloud-server system. The lock and swing arm will operate to open/close and lock/unlock a door. Once the smartphone app, which is downloaded and running on the user's smart device, has been verified by the service provider, it can be utilized to control the functioning of the swing arm and lock. In one embodiment, the smartphone app can control the swing arm and lock of multiple dog kennel crates, to allow the crates to open simultaneously or one at a time, depending on the needs and/or wants of a user.

In one embodiment, when the user wishes to open the dog kennel crate, the user must activate the smartphone app. The user then selects to unlock the lock and/or open the door of the dog kennel crate, and the smartphone application sends an unlock and/or open-door request to the dog kennel crate. The dog kennel crate responds with an acknowledge message which may be sent by the smartphone application to the service provider. The smartphone application then unlocks the lock and opens the door.

Typically, the communication between the network service and the animal crate locking device will be executed using the internet, whilst the communication between the smart device and the lock and/or swing arm will be over a communication channel for short-range communication, such as Bluetooth, NFC, Wi-Fi, proprietary communication protocol or other.

In one embodiment, for security purposes, the smart device, may be communicating with either one or both of the lock, swing arm, and online service provider over an encrypted communication channel.

In one embodiment, the control box component comprises integrated electronics, including one or more processors (i.e., microprocessor, controller, ASIC, etc.) to execute program code (i.e., software, firmware, etc.) stored in a nonvolatile computer readable storage device (i.e., memory) to enable the function of the device.

In one embodiment, sensors that are tied into the home security system can be positioned on windows and doors to communicate with the device. Instead of a smart device, the home security system is utilized to control the open/close of the door via the swing arm and the unlock/lock of the lock. In this embodiment, whenever an exterior door or window is opened, the door of the device is also opened, etc.

In one embodiment, the control box component comprises a power supply component, such as an AC adapter, which is configured to engage a power cord which is plugged into a standard wall outlet. Instead of an AC adapter, the device can utilize rechargeable batteries or an

USB component. Further, the control box component can also include a DC adaptor, such that the animal crate can be mobile and transported in a vehicle.

In one embodiment, the control box component comprises a power detector which detects lack of power or a poor power source and then sends an alert or triggers an alarm, and a message may be communicated to the user of the smart device.

In one embodiment, the dog kennel crate may further comprise one or more light sources. These light sources may be controlled by the controller and may serve different purposes.

One is to light up the interior of the dog kennel crate, wherein the light is comprised of normal light sources for providing visible light when the dog kennel crate is occupied by a pet or other live animal.

In yet another embodiment, the animal crate locking device comprises a plurality of indicia.

In yet another embodiment, a method of automatically controlling the operation of a kennel door via a Wi-Fi signal is disclosed. The method includes the steps of providing an animal crate locking device comprising a body component with a control box component secured to the side of the body component and a swing arm. The method also comprises securing the swing arm to the kennel door. Further, the method comprises connecting the swing arm to a Wi-Fi signal via the components in the control box component. The method comprises operating the opening and closing of the kennel door via a mobile software application and smart device. Finally, the method comprises operating the opening and closing of the kennel door via a home security system, such that the kennel door is opened whenever an exterior door or window is opened.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top perspective view of one embodiment of the animal crate locking device of the present invention showing the control box and swing arm in accordance with the disclosed architecture;

FIG. 2 illustrates a side perspective view of one embodiment of the animal crate locking device of the present invention showing the swing arm extended out in accordance with the disclosed architecture;

FIG. 3 illustrates a perspective view of one embodiment of the animal crate locking device of the present invention showing the device in use; and

FIG. 4 illustrates a flowchart showing the method of automatically controlling the operation of a kennel door via a Wi-Fi signal in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an animal crate locking device that provides users with an improved dog kennel crate with a door that can be operated via a home Wi-Fi network. There is also a long-felt need in the art for an animal crate locking device that allows pet owners to connect the crate to a home network or security system, enabling it to be opened at any time through a software application. Further, there is a long-felt need in the art for an animal crate locking device that enables users to auto open the kennel door on command. Moreover, there is a long-felt need in the art for a device that enables users to auto open the kennel door via a home security system. Further, there is a long-felt need in the art for an animal crate locking device that can be programmed, such that the kennel door opens whenever an exterior door or window is opened. Finally, there is a long-felt need in the art for an animal crate locking device that prevents pets from being stuck in their kennel until a pet owner manually unlatches the kennel door.

The present invention, in one exemplary embodiment, is a novel animal crate locking device. The animal crate locking device comprises a body component comprised of a conventional dog kennel crate. Typically, a control box component which houses all the necessary components is secured to the side of the body component. The control box component also comprises a swing arm that can be attached to the kennel door. The control box component comprises means to be connected to a home network and/or security system via a Wi-Fi signal, thereby allowing the user to operate the kennel door via the swing arm at any time through a mobile software application and smart device or programmed to the home security system. The present invention also includes a novel method of automatically controlling the operation of a kennel door via a Wi-Fi signal. The method includes the steps of providing an animal crate locking device comprising a body component with a control box component secured to the side of the body component and a swing arm. The method also comprises securing the swing arm to the kennel door. Further, the method comprises connecting the swing arm to a Wi-Fi signal via the components in the control box component. The method comprises operating the opening and closing of the kennel door via a mobile software application and smart device. Finally, the method comprises operating the opening and closing of the kennel door via a home security system, such that the kennel door is opened whenever an exterior door or window is opened.

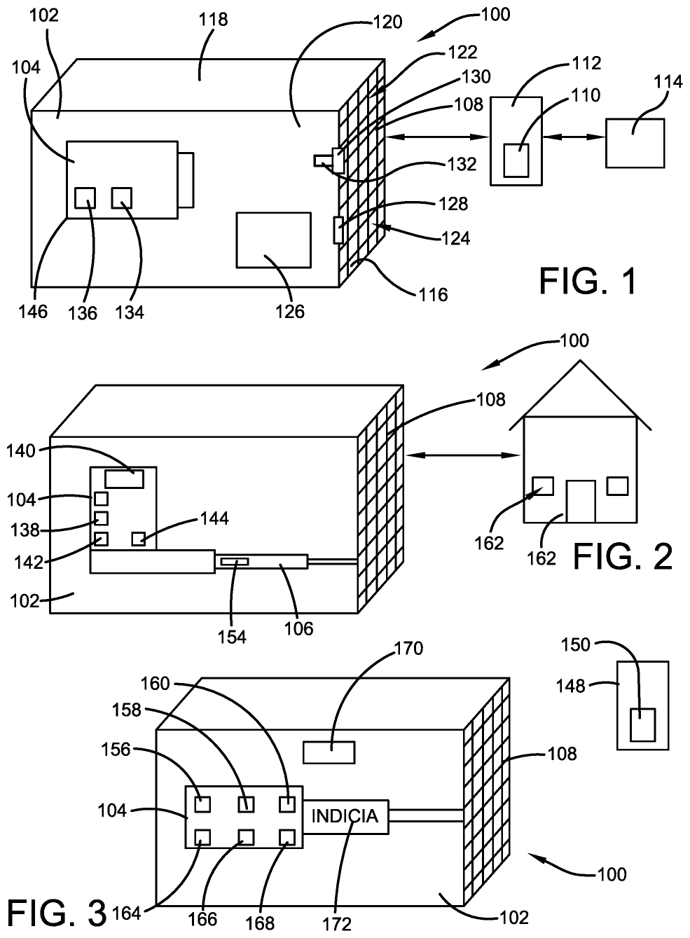

Referring initially to the drawings, FIGS. 1-3 illustrate a perspective view of one embodiment of the animal crate locking device 100 of the present invention. In the present embodiment, the animal crate locking device 100 is an improved animal crate locking device 100 that allows a kennel door 108 to be operated wirelessly through Wi-Fi. Specifically, the animal crate locking device 100 comprises a body component 102 which is a conventional dog kennel crate and a control box component 104 and swing arm 106 secured to the body component 102. The control box component 104 comprises means to be connected to a home network and/or security system 114 via a Wi-Fi signal, thereby allowing the user to operate the kennel door 108 via the swing arm 106 at any time through a mobile software application 110 and smart device 112 or through a home security system 114.

Generally, the animal crate locking device 100 can be utilized with any animal crate as is known in the art for temporary storage of a pet. Specifically, the animal crate locking device 100 can be utilized with a dog kennel, a cat kennel, a hamster, other rodent kennel, etc., or any other suitable animal kennel as is known in the art.

Furthermore, the animal crate locking device 100 comprises a body component 102 which is a conventional dog kennel crate. Generally, the animal crate locking device 100 comprises a body component 102 that is generally box-shaped with a floor 116, a roof 118, and side walls 120. The six faces 116, 118, and 120 may be connected to each other using push-fit fasteners to facilitate assembly without tools. The body component 102 has a door opening 122 in which the animal may enter/exit. In one embodiment, the door opening 122 may include a movable door 108 (i.e., hinged or sliding) that may be opened or shut to prevent access to the interior 124 of the body component 102. The walls 120 of the body component 102 may include one or more openings 126 (i.e., windows) that allow for ventilation and/or light. Further, the body component 102 comprises a door 108 attached to the dog kennel crate via at least one spring-loaded hinge 128. The door 108 locks in a closed state or unlocks and opens with respect to the dog kennel crate via a lock 130. In one embodiment, the lock 130 is a magnetic lock that functions via an electromagnet.

In another embodiment, the lock 130 is engaged via a locking motor 132. Rotational movement of the lock 130 is accomplished either through manual rotation via a user or via the locking motor 132, which in effect locks or unlocks the door 108 with respect to the dog kennel crate. The locking motor 132 is powered via electrical power comprised by at least one battery 134 (which may be recharged) and controlled via a central processing unit 136 within the control box component 104. The central processing unit 136 is in wired communication with a receiver 138, which communicates with the locking motor 132.

Generally, the control box component 104 is able to communicate wirelessly with the lock 130. The control box component 104 includes a touch screen 140, a Bluetooth transceiver 142, a cellular transceiver 144, and the central processing unit 136. The control box component 104 includes a housing 146, which may be affixed to the dog kennel crate (i.e., body component 102) or door 108 directly. Alternatively, the housing 146 of the control box component 104 may not be affixed to the dog kennel crate or the door 108 in order for the control box component 104 to be a hand-held remote device 148. Further, the housing 146 includes the touch screen 140, as well as an on/off button 150, and a plug port 152. The plug port 152 enables an electrical cord to plug into and recharge the control box component 104.

Further, the control box component 104 is secured to the dog kennel crate via any suitable securing means as is known in the art. The control box component 104 also comprises a swing arm 106 that can be attached to the door 108. The swing arm 106 is adjustable and controlled by an arm motor 154. Specifically, the swing arm 106 is engaged via the arm motor 154, which acts to open and close the door 108.

Generally, the control box component 104 comprises all the necessary components needed for operating the animal crate locking device 100 and the swing arm 106 to open and close the door 108. Specifically, the control box component 104 comprises at least one controller 156, wherein the controller 156 is able to communicate with a smart device 112, the lock 130, and swing arm 106. The lock 130 further comprises an electronic interface for operation, such that the controller 156 can control the operation of the lock 130.

Further, the Bluetooth transceiver 142 of the control box component 104 enables a smart phone 112 to communicate with the device 100. Moreover, the cellular transceiver 144 of the control box component 104 enables the smart device 112 or a home security system 114 to communicate with the device 100. The cellular transceiver 144 shall work in the event the smart device 112 is out of range of use with the Bluetooth transceiver 142. The cellular transceiver 144 communicates directly with a cell phone tower in order to facilitate communication with the smart device 112 or the home security system 114.

In one embodiment, the smart device 112 is preferably a smartphone running a software application 110 to support the features of the device 100. The smartphone application 110 provides, when activated, an online connection to an online service provider, and will, when communicating with the swing arm 106 and lock 130, communicate with the swing arm 106 and lock 130 over a short range, such as Wi-Fi/Bluetooth/NFC, communication protocol. Other standard or short-range communication protocols may be used, also proprietary protocols.

Further, the smart device 112 many be any suitable smart device, such as a handheld device, phone, tablet, etc., and may be any type of remote controller 148 implementing the user interface toward the lock 130 and swing arm 106 operation and to a cloud-server system. The lock 130 and swing arm 106 will operate to open/close and lock/unlock a door 108. Once the smartphone application 110 which is downloaded and running on the user's smart device 112 has been verified by the service provider, it can be utilized to control the functioning of the swing arm 106 and lock 108. In one embodiment, the smartphone app 110 can control the swing arm 106 and lock 108 of multiple dog kennel crates, to allow the crates to open simultaneously or one at a time, depending on the needs and/or wants of a user.

Accordingly, when the user wishes to open the dog kennel crate, the user must activate the smartphone application 110. The user then selects to unlock the lock 130 and/or open the door 108 of the dog kennel crate, and the smartphone application 110 sends an unlock and/or open-door request to the dog kennel crate. The dog kennel crate responds with an acknowledge message which may be sent by the smartphone application 110 to the service provider. The smartphone application 110 then unlocks the lock 130 and opens the door 108.

Typically, the communication between the network service and the animal crate locking device 100 will be executed using the internet, whilst the communication between the smart device 112 and the lock 130 and/or swing arm 106 will be over a communication channel for short-range communication, such as Bluetooth, NFC, Wi-Fi, proprietary communication protocol or other.

In one embodiment, for security purposes, the smart device 112, may be communicating with either one or both of the lock 130, swing arm 106, and online service provider over an encrypted communication channel, as needed or depending on the needs and/or wants of a user.

In another embodiment, the control box component 104 comprises integrated electronics, including one or more processors 158 (i.e., microprocessor, controller, ASIC, etc.) to execute program code (i.e., software, firmware, etc.) stored in a nonvolatile computer readable storage device (i.e., memory 160) to enable the function of the device 100.

In one embodiment, sensors 162 that are tied into the home security system 114 can be positioned on windows and doors to communicate with the device 100. Instead of a smart device 112, the home security system 114 is utilized to control the open/close of the door 108 via the swing arm 106 and the unlock/lock of the lock 130. In this embodiment, whenever an exterior door or window is opened, the door 108 of the device 100 is also opened, etc.

Generally, the control box component 104 comprises a power supply component, such as an AC adapter 164, which is configured to engage a power cord 166 which is plugged into a standard wall outlet. Instead of an AC adapter 164, the device 100 can utilize rechargeable batteries 134 or an USB component 166. Further, the control box component 104 can also include a DC adaptor, such that the animal crate can be mobile and transported in a vehicle.

In another embodiment, the control box component 104 comprises a battery component 134. The battery component 134 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the animal crate locking device 100. Throughout this specification, the term “battery” may be used interchangeably to refer to one or more wet or dry cells or batteries of cells in which chemical energy is converted into electricity and used as a source of DC power. References to recharging or replacing the battery 134 may refer to recharging or replacing individual cells, individual batteries of cells, or a package of multiple battery cells as is appropriate for any given battery technology that may be used. In addition, a rechargeable embodiment of the battery 134 may be recharged using a USB port (not shown), wherein the USB port is a USB-A, USB-B, Micro-B, Micro-USB, Mini-USB, or USB-C port, etc.

In one embodiment, the control box component 104 comprises a power detector 168 which detects lack of power or a poor power source and then sends an alert or triggers an alarm, and a message may be communicated to the user of the smart device 112.

In another embodiment, the dog kennel crate may further comprise one or more light sources 170. These light sources 170 may be controlled by the controller 156 and may serve different purposes. One is to light up the interior 124 of the dog kennel crate, wherein the light is comprised of normal light sources for providing visible light when the dog kennel crate is occupied by a pet or other live animal.

In yet another embodiment, the animal crate locking device 100 comprises a plurality of indicia 172. The body component 102 of the device 100 may include advertising, trademark, other letters, designs, or characters, printed, painted, stamped, or integrated into the body component 102, or any other indicia 172 as is known in the art. Specifically, any suitable indicia 172 as is known in the art can be included, such as, but not limited to, patterns, logos, emblems, images, symbols, designs, letters, words, characters, animals, advertisements, brands, etc., that may or may not be kennel, animal, or brand related.

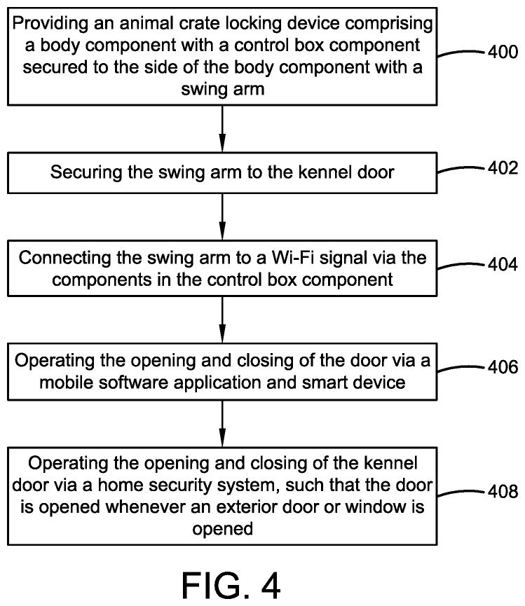

FIG. 4 illustrates a flowchart of the method of automatically controlling the operation of a kennel door via a Wi-Fi signal. The method includes the steps of at 400, providing an animal crate locking device comprising a body component with a control box component secured to the side of the body component and a swing arm. The method also comprises at 402, securing the swing arm to the kennel door. Further, the method comprises at 404, connecting the swing arm to a Wi-Fi signal via the components in the control box component. The method comprises at 406, operating the opening and closing of the kennel door via a mobile software application and smart device. Finally, the method comprises at 408, operating the opening and closing of the kennel door via a home security system, such that the kennel door is opened whenever an exterior door or window is opened.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “animal crate locking device”, “locking device”, “animal crate device”, and “device” are interchangeable and refer to the animal crate locking device 100 of the present invention.

Notwithstanding the foregoing, the animal crate locking device 100 of the present invention can be of any suitable size and configuration as is known in the art without affecting the overall concept of the invention, provided that it accomplishes the above-stated objectives. One of ordinary skill in the art will appreciate that the animal crate locking device 100 as shown in FIGS. 1-4 are for illustrative purposes only, and that many other sizes and shapes of the animal crate locking device 100 are well within the scope of the present disclosure. Although the dimensions of the animal crate locking device 100 are important design parameters for user convenience, the animal crate locking device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An animal crate locking device that allows a kennel door to be operated wirelessly through Wi-Fi, the animal crate locking device comprising:
a body component with a door;
a control box component; and
a swing arm;
wherein the body component houses an animal; and
wherein the control box component is secured to the body component;
wherein the swing arm is secured to the door; and
further wherein the control box component communicates with a Wi-Fi signal to operate the door via the swing arm.

2. The animal crate locking device of claim 1, wherein the body component comprises a floor, a roof, and side walls, which are secured together in a box-like configuration.

3. The animal crate locking device of claim 2, wherein the body component has a door opening in which the animal may enter and exit, which is secured by the door with a lock.

4. The animal crate locking device of claim 3, wherein the lock is a magnetic lock that functions via an electromagnet.

5. The animal crate locking device of claim 3, wherein the lock is engaged via a locking motor, which is powered via at least one battery and controlled via a central processing unit that is in wired communication with a receiver.

6. The animal crate locking device of claim 5, wherein the control box component is able to communicate wirelessly with the lock.

7. The animal crate locking device of claim 6, wherein the control box component comprises a housing affixed to the base component and including a touch screen, a Bluetooth transceiver, a cellular transceiver, a controller, and the central processing unit.

8. The animal crate locking device of claim 7, wherein the swing arm is adjustable and is secured to the door and engages an arm motor to open and close the door.

9. The animal crate locking device of claim 8, wherein the Bluetooth transceiver of the control box component enables a smart device to communicate with the animal crate locking device.

10. The animal crate locking device of claim 9, wherein the smart device engages a Smartphone software application to support features of the animal crate locking device.

11. The animal crate locking device of claim 10, wherein the Smartphone software application provides, when activated, an online connection to an online service provider, and will when communicating with the swing arm and the lock communicate over a Wi-Fi or Bluetooth communication protocol.

12. The animal crate locking device of claim 11, wherein the control box component communicates wirelessly with a home security system, such that sensors that are tied into the home security system can be positioned on windows and doors to control the door and the lock.

13. The animal crate locking device of claim 12, wherein the control box component comprises an AC adapter and rechargeable batteries for power.

14. An animal crate locking device that allows a kennel door to be operated wirelessly through Wi-Fi, the animal crate locking device comprising:
a body component which comprises a floor, a roof, and side walls, which are secured together in a box-like configuration with a door;
a control box component; and
a swing arm;
wherein the body component houses an animal wherein the body component has a door opening in which the animal may enter and exit, which is secured by a door with a lock;
wherein the lock is a magnetic lock that functions via an electromagnet;
wherein the control box component is secured to the body component;
wherein the swing arm is secured to the door;
wherein the control box component communicates wirelessly with a Wi-Fi signal to operate the door via the swing arm;
wherein the control box component comprises a housing affixed to the base component and including a touch screen, a Bluetooth transceiver, a cellular transceiver, a controller, and a central processing unit;
wherein the swing arm is adjustable and is secured to the door and engages an arm motor to open and close the door;
wherein the Bluetooth transceiver of the control box component enables a smart device to communicate with the animal crate locking device;
wherein the smart device engages a Smartphone software application to support features of the animal crate locking device; and
wherein the Smartphone software application provides, when activated, an online connection to an online service provider, and will when communicating with the swing arm and the lock communicate over a Wi-Fi or Bluetooth communication protocol.

15. The animal crate locking device of claim 14 further comprising a plurality of indicia.

16. The animal crate locking device of claim 14, wherein the control box component communicates wirelessly with a home security system, such that sensors that are tied into the home security system can be positioned on windows and doors to control the door and the lock.

17. The animal crate locking device of claim 14, wherein the control box component comprises a DC adapter.

18. The animal crate locking device of claim 14, wherein the lock is engaged via a locking motor, which is powered via at least one battery and controlled via the central processing unit that is in wired communication with a receiver.

19. The animal crate locking device of claim 18, wherein the control box component is able to communicate wirelessly with multiple locks of multiple body components to allow the doors to open simultaneously or one at a time.

20. A method of automatically controlling the operation of a kennel door via a Wi-Fi signal, the method comprising the following steps:
providing an animal crate locking device comprising a body component with a control box component secured to the side of the body component and a swing arm;
securing the swing arm to the kennel door;
connecting the swing arm to a Wi-Fi signal via the components in the control box component;
operating the opening and closing of the kennel door via a mobile software application and smart device; and
operating the opening and closing of the kennel door via a home security system, such that the kennel door is opened whenever an exterior door or window is opened.
